(19) United States
(12) Patent Application Publication
(10) Pub. No.: US 2024/0173843 A1
(43) Pub. Date: May 30, 2024

(54) Container Door Leverage Bar with Interchangeable Tools

(71) Applicant: Paolo Galido, Whittier, CA (US)

(72) Inventor: Paolo Galido, Whittier, CA (US)

(21) Appl. No.: 18/058,737

(22) Filed: Nov. 24, 2022

(51) Int. Cl. B25G 3/30; E05B 1/00

(52) U.S. Cl. CPC B25G 3/30; E05B 1/0053; B25G 1/102

(57) ABSTRACT

A container door leverage bar with interchangeable tools is disclosed. The device is comprised of a cylindrical, hollow bar with an elliptical head and grip at the rear. The elliptical head is adapted to receive a conventional transport container door handle therein to allow users to easily open and close container doors. A threaded portion at the grip can also receive a plurality of other tools such as pry bars, ratchets, twist locks etc. An object of the invention is to allow a leverage bar to open and close doors as well as top perform a multitude of other tasks associated with container transportation and manual hand leverage.

### FIELD OF THE INVENTION

The present invention generally relates to transportation tools. More specifically, it relates to a container door leverage tool that allows user to perform additional tasks relating to container transportation and manual hand leverage.

### BACKGROUND

Intermodal shipping containers (also known as cargo containers) were first developed in the mid 1950 by Malcom McLean and has since revolutionized shipping and global trade. The change was significant at the time in that the shipping container allowed cargo to be seamlessly transported between road, rail and ocean vessels. The world's first container ship, a converted World War II tanker travelled from the port of Newark to the port of Houston in 1956 and carried 58 shipping containers. In 1968 the International Standards Organization standardized this invention as a standard box. The box was identified as being 20 foot long, 8 foot high and 8 foot wide. From then on ships were then completely re-designed around the dimensions of these boxes. Shipping costs plummeted and it became cheaper to manufacture goods on the other side of the world because shipping became so cheap. Since then the shipping container has revolutionized ports, rail networks, ships, cities and countries all over the world. The shipping container has been one of the single biggest catalyst of globalization. While these containers have revolutionized international trade, their door mechanics can be less than user friendly and they were not designed with ergonomics in mind. In an effort to assist workers in opening these doors, independent companies began developing leverage tools. United States Patent No. US20070096473A1 granted to Vincent Ortega disclosed a shipping-container door handle extender for opening container doors and also includes a fifth wheel handle pull notch; however it can only perform two functions. United States Patent No. US20130247351A1 granted to Joseph H. Stutson disclosed a V-shaped container door leverage tool; however, it only performs a single door opening function. British Patent GB2553826A granted to John Miller Edward and Edward Miller Ian disclosed a container door handle opener that telescopes but does not include other functions. United States Patent No. US20130086845A1 granted to Keith Steven High disclosed a latch tool for cargo doors; however, it is mainly compatible with side-hinged doors on hauling containers (such as dump trucks etc.) and is not designed for standard shipping container doors. While these devices can assist users with opening container doors more easily, they are limited to a one or two functions. What is needed is a container door, leverage tool that can perform a host of other functions with multiple attachment.

### SUMMARY OF THE INVENTION

The device herein disclosed and described provides a solution to the shortcomings in the prior art through the disclosure of a container door leverage bar with interchangeable tools. Said containers can include but are not limited to dry freight containers and refrigerator transport unit doors etc. The main object of the device is to allow users to open and close difficult-to-open, difficult-to-close, container doors with less effort by providing a longer handle that provides additional leverage. Such doors may be difficult for many reasons—they may iced over, they can rust and pit together during prolonged periods of inactivity or can lack proper lubrication. The device has a hollow end that slips over existing container door handles and a grip on the other end that is easily gripped by the hands. In addition, the device contributes to minimizing strains associated with attempting to open jammed container door handles by providing extra torque when turning handles attached to vertical door seals and cams.

Another object of the device is to allow a user to generate extra torque to open or close a container door handle and not come in contact with container corners. The offset bend in the device's handle allows the device to be used on outer container handles that are close to corner panels that usually extend beyond standard containers' footprint.

Another object of the device is to provide a means to allow the device to be used for other functions. The grip portion has a threaded aperture that allows a user to secure any number of other proprietary tools that have a mating, threaded rod ends—such as pry bars, hammers, and ratchets etc. One embodiment even includes a quick disconnect fitting for tools.

Another object of the device is to allow a user to easily operate a ‘5th wheel release hook.’ An embodiment of the device has a small, angled notch on the end and users can secure it to the release hook and pull on the handle it to activate the hitch coupling and separate a trailer from the tractor. Other embodiments include a threaded hook rod that screws into the device's handle which provides a longer, extended reach.

Another object of the device is to allow a user check tire inflation status—a procedure known as ‘tire thumping.’ The user taps each tire with the device and listens for the sound generated. Tires that are full will generate a sharp bounce sound. Tires that are low will generate a dull thud.

Another object of the device is to allow users to open or close door handles that may have rubber grips. Another embodiment of the device has a larger opening to accommodate larger container door handles.

Another object of the device is to allow users to pry on doors and other transport equipment. Additional embodiments include attachments such as a pry bar for heavy objects and a small pry tool for smaller joints.

Another object of the device is to allow users to easily transport it on their persons. The device includes a small D-ring that can attach to a user's belt with a snap bolt etc. and wear it on their waist.

Another object of the device is to provide additional ergonomic support. The device easily fits into the hand and has a flexible, comfortable grip. The remaining outer surface is also coated with a slip-resistant coating that repels oils and moisture.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows the container door leverage bar being used on a container door.

FIG. 2 shows a side view of an embodiment of the container door leverage bar.

FIG. 3 shows a side view of another embodiment of the container door leverage bar.

FIG. 4 shows a perspective view of the container door leverage bar attachments.

FIG. 5 shows a perspective view of the container door leverage bar attachments.

FIG. 6 shows a perspective view of the device operating a fifth wheel release.

FIG. 7 shows a perspective view of the container door leverage bar used with a ratchet.

FIG. 8 shows a perspective view of the container door leverage bar used on a fifth wheel release.

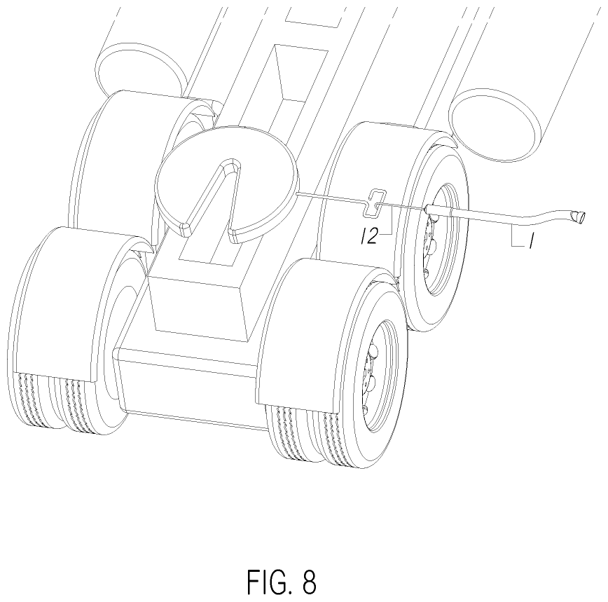

FIG. 9 shows a perspective view of the container door leverage bar used with a quick release.

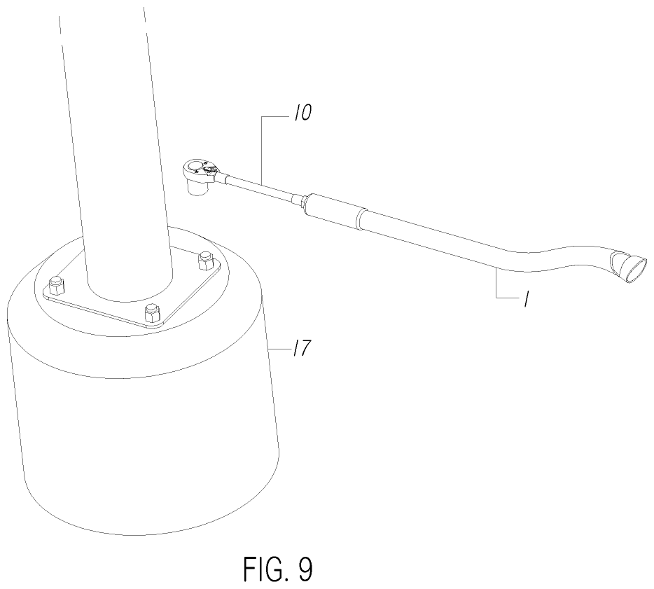

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

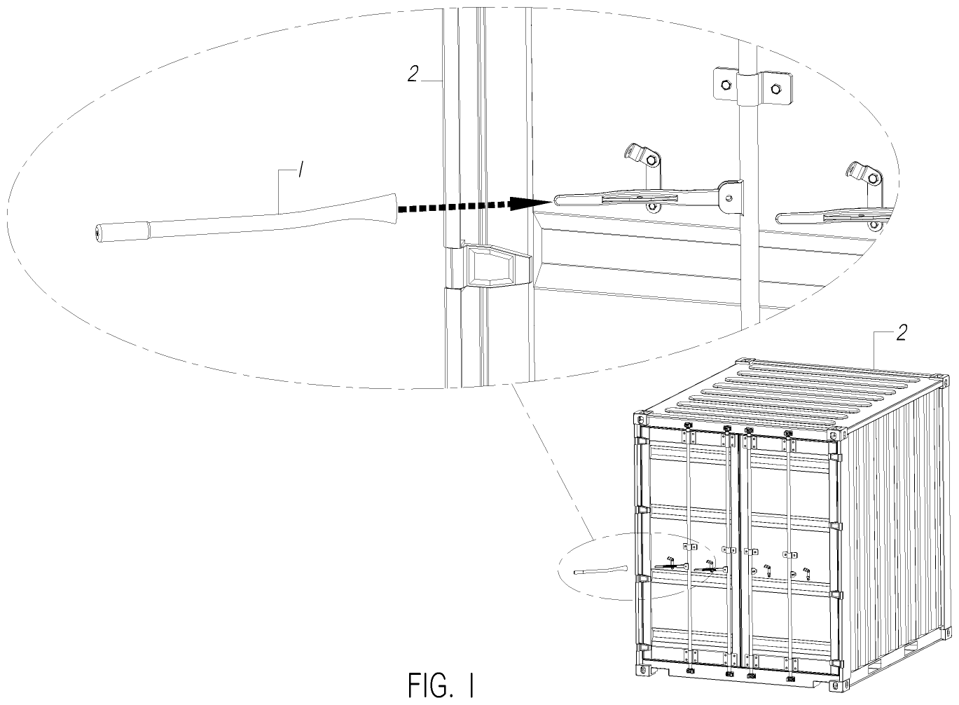

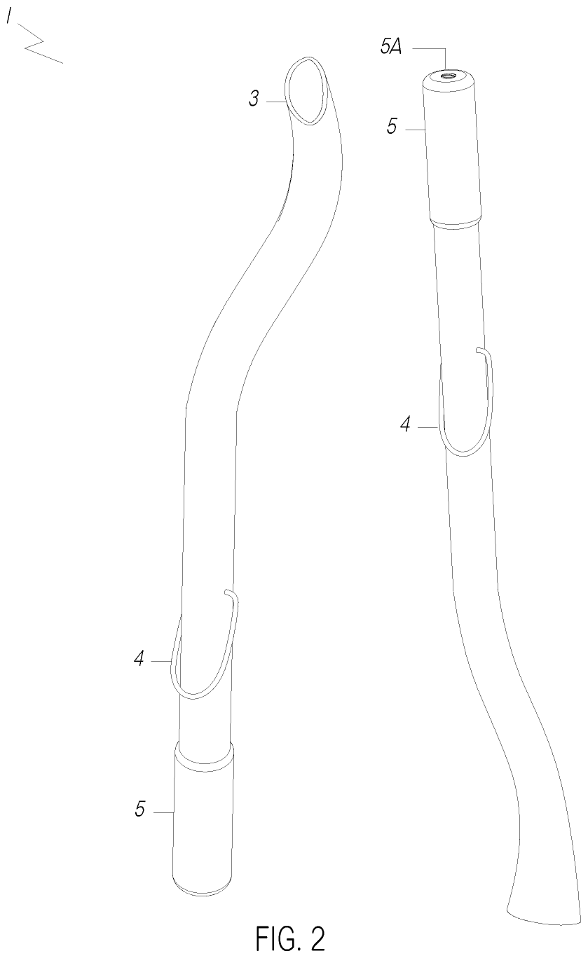

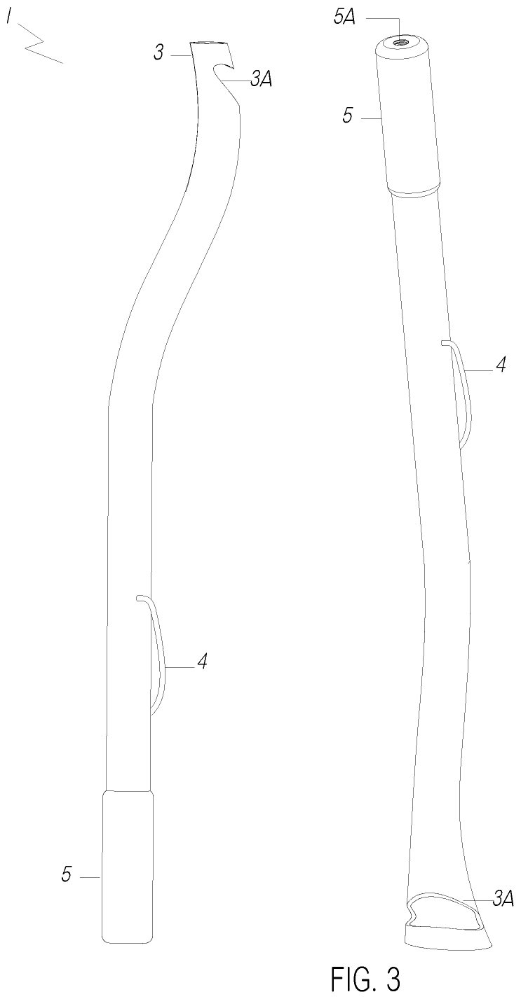

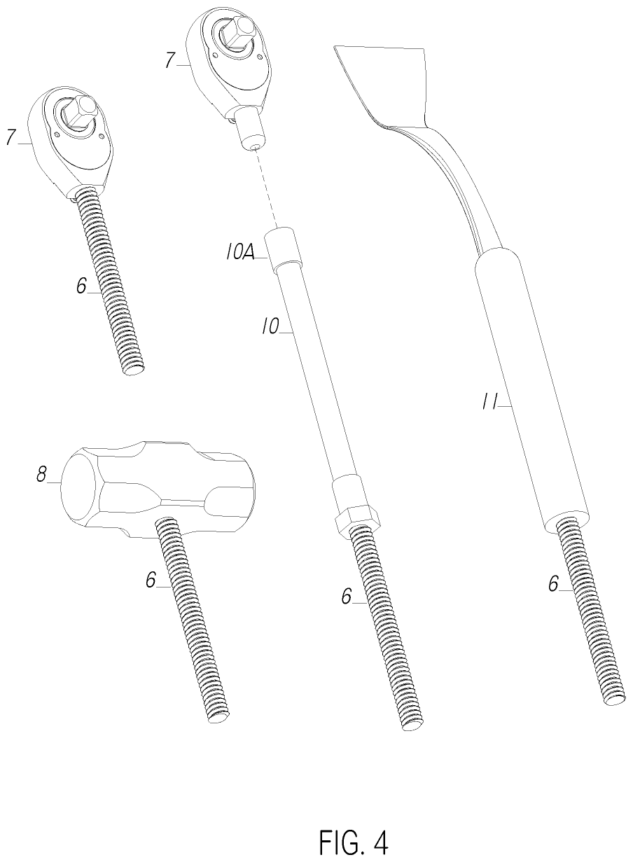

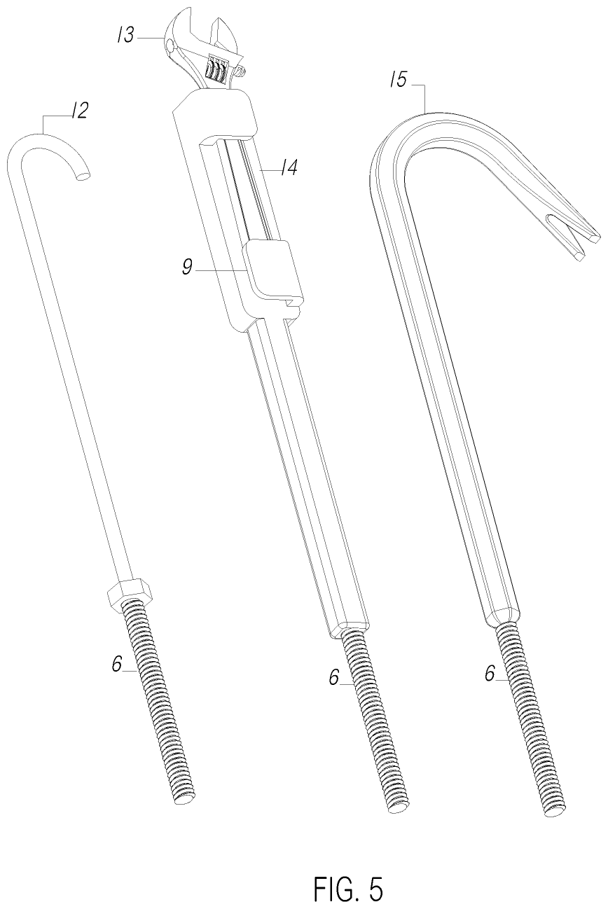

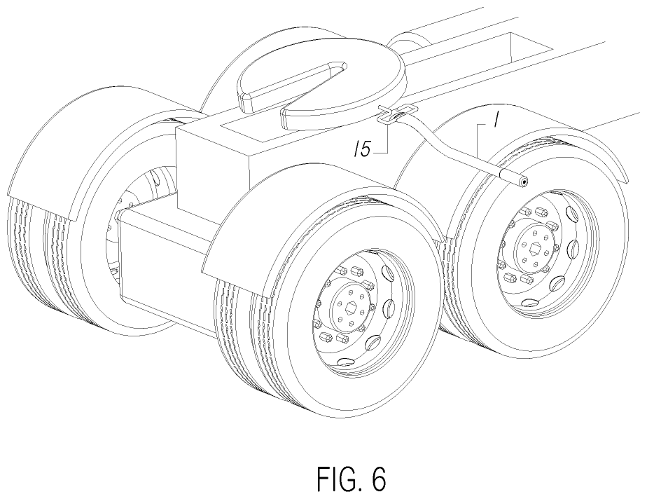

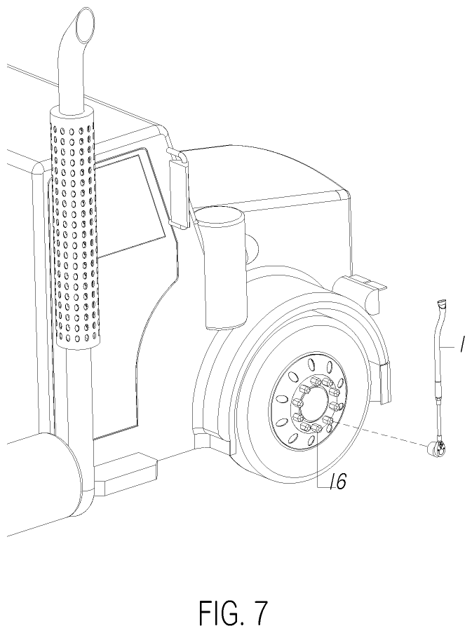

FIG. 1 shows a preferred embodiment of container door leverage bar 1 installed on door lever of standard, conventional container 2. FIG. 2 shows various side views of container door leverage bar 1 comprised of a hollow, cylindrical tube with an elliptical aperture 3 on one end and a grip 5 on another end. An end of said grip 5 having a threaded aperture 5A (imperial or metric) thereon. The proximal portion of container door leverage bar 1 being offset slightly and having a D-ring 4 (made of a metal, plastic etc.) pivotably-affixed thereon. Container door leverage bar 1 being made of a rigid material including but not limited to steel, stainless steel, aluminum and the like. Said grip 5 having a cylindrical-shape and being hollow to receive said container door leverage bar 1 and is made of a rigid, but soft material—including but not limited to rubber, EVA foam, silicone and the like. FIG. 3 showing side views of another embodiment of the device having an elliptical slot 3A at the elliptical aperture 3 configured to receive a standard fifth wheel release handle therein. FIGS. 4 and 5 showing various tools that are selectively affixed to the container door leverage bar by means of threaded rod 6 attached to each tool that engages threaded aperture 5A on container door leverage bar 1. Said tools include but are not limited to ratchet 7, hammer 8, chisel 11, fifth wheel release hook 12, and prybar 15. Other embodiments can include a quick release rod 10 comprised of a threaded rod having locking slide collar 10A with ball and/or a ring detent to selectively lock a tool therein. Still other embodiments can include tool holder 15 with armatures 9 that selectively hold a variety of tools therein such as crescent wrench 13. FIG. 6 showing a perspective view of container door leverage bar 1 engaging fifth wheel release handle 15 and FIG. 7 showing another embodiment of the container door leverage bar 1 with quick disconnect and ratchet attachment interacting with truck wheel lug nut 18.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1.) A container door lever bar comprised of the following parts:
a) a tube;
b) a plurality of tools; and
c) a quick disconnect.

2.) The container door lever bar of claim 1, wherein the tube being cylindrical and hollow.

3.) The container door lever bar of claim 1, wherein the tube having an offset on a proximal portion.

4.) The container door lever bar of claim 1, wherein the tube having an elliptical aperture on one end.

5.) The container door lever bar of claim 1, wherein the tube having a grip on one end.

6.) The container door lever bar of claim 1, wherein the tube having a D-ring.

7.) The container door lever bar of claim 1, wherein the tube having the elliptical aperture on one end and the grip on another end.

8.) The container door lever bar of claim 1, wherein the grip having a threaded aperture.

9.) The container door lever bar of claim 1, wherein the plurality of tools have a threaded rod on one end.

10.) The container door lever bar of claim 1, wherein the plurality of tools have a threaded rod.
